(19) United States
(12) Patent Application Publication
(10) Pub. No.: US 2014/0186018 A1
(43) Pub. Date: Jul. 3, 2014

(54) CAMERA MODULE

(71) Applicant: FIH (Hong Kong) Limited, Kowloon (HK)

(72) Inventor: PAO-CHUN LIN, New Taipei (TW)

(73) Assignee: FIH (HONG KONG) LIMITED, Kowloon (HK)

(21) Appl. No.: 13/966,683

(22) Filed: Aug. 14, 2013

(30) Foreign Application Priority Data
Dec. 29, 2012 (CN) 2012105886560

(51) Int. Cl. G03B 17/12

(52) U.S. Cl. CPC G03B 17/12
USPC 396/529

(57) ABSTRACT

The disclosure provides a camera module including a light penetration chamber, a transparent window, a gasket, and a lens module. The transparent window covers the light penetration chamber. The gasket is integrally formed with the transparent window. The gasket includes a receiving cavity coaxial with the light penetration chamber. The lens module is received in the receiving cavity. The lens module includes a lens exposing hole that aligns with and is coaxial with the light penetration chamber, the lens exposing hole allows ambient light to be transmitted into the lens module.

### BACKGROUND

1. Technical Field

The exemplary disclosure generally relates to camera modules, and particularly to a camera module employing a gasket.

2. Description of Related Art

A camera for portable electronic devices often has a lens module with a gasket and a transparent window. The gasket seals the lens module to protect the lens module from contamination. Since the gasket and the transparent window are molded individually, and are then assembled to the lens module, the central axis of the lens module sometimes deviates from the standard position, which can badly affect image quality.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 is an isometric view of a camera module, according to an exemplary embodiment.

FIG. 2 is an exploded view of the camera module of FIG. 1.

FIG. 3 is an isometric view of a gasket of the camera module of FIG. 1.

FIG. 4 is an enlarged and cross-sectional view of the camera module shown in FIG. 1 taken along a line IV-IV of FIG. 1.

### DETAILED DESCRIPTION

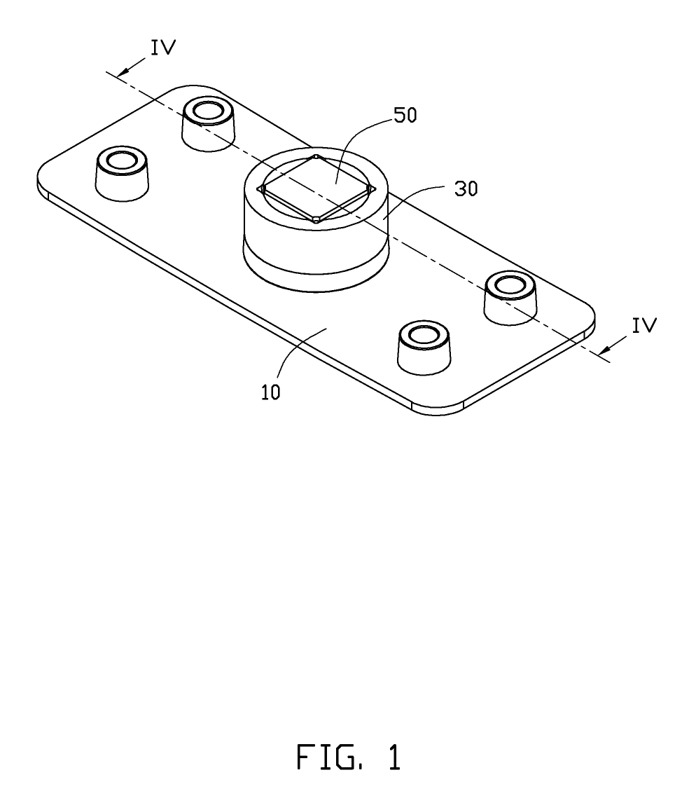

FIG. 1 is an isometric view of a camera module 100, according to an exemplary embodiment. The camera module 100 includes a transparent window 10, a gasket 30, and a lens module 50. The gasket 30 is positioned between the transparent window 10 and the lens module 50. In the embodiment, the transparent window 10 is made of transparent plastic material, and the gasket 30 is made of semigloss elastic material such as thermoplastic polyurethane. The transparent window 10 and the gasket 30 are integrally formed together. For example, the transparent window 10 and the gasket 30 can be made by double-colored injection molding technology.

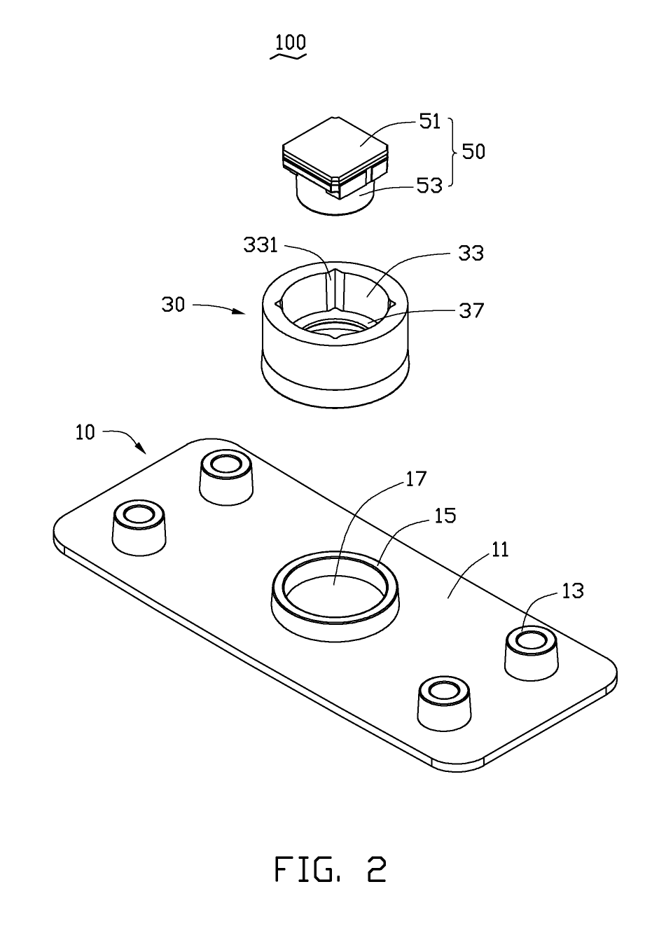

FIG. 2 is an exploded view of the camera module of FIG. 1. The transparent window 10 includes a board 11, a plurality of mounting posts 13 protruding from the board 11, and a connecting arm 15 protruding from the board 11. The mounting posts 13 are configured to be fixed to a portable electronic device (not shown), thereby mounting the transparent window 10 to the portable electronic device. For example, the mounting posts 13 can be fixed to the portable electronic device by hot melt technology or by screw. In the exemplary embodiment, the transparent window 10 includes four mounting posts 13, which are positioned at four corners of the transparent window 10. The connecting arm 15 is fixed to the gasket 30. In the exemplary embodiment, the connecting arm 15 protrudes from a middle portion of the transparent window 10. The connecting arm 15 is a hollow cylinder which cooperates with the board 11 in defining a light penetration chamber 17.

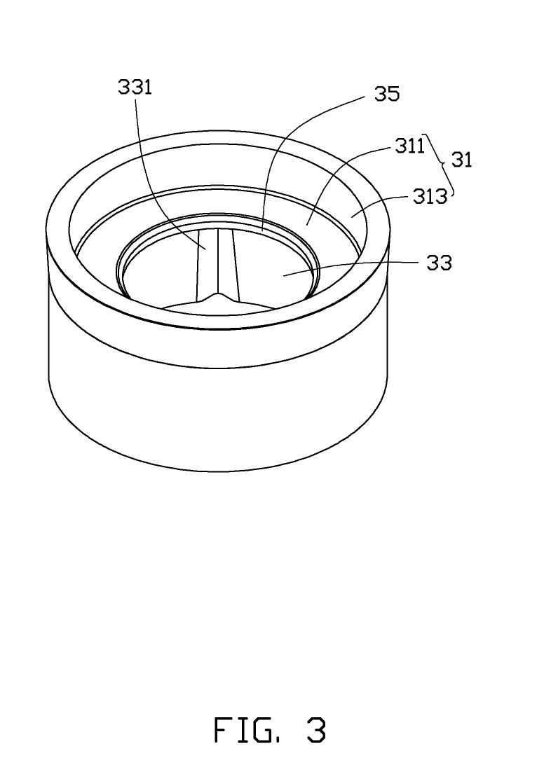

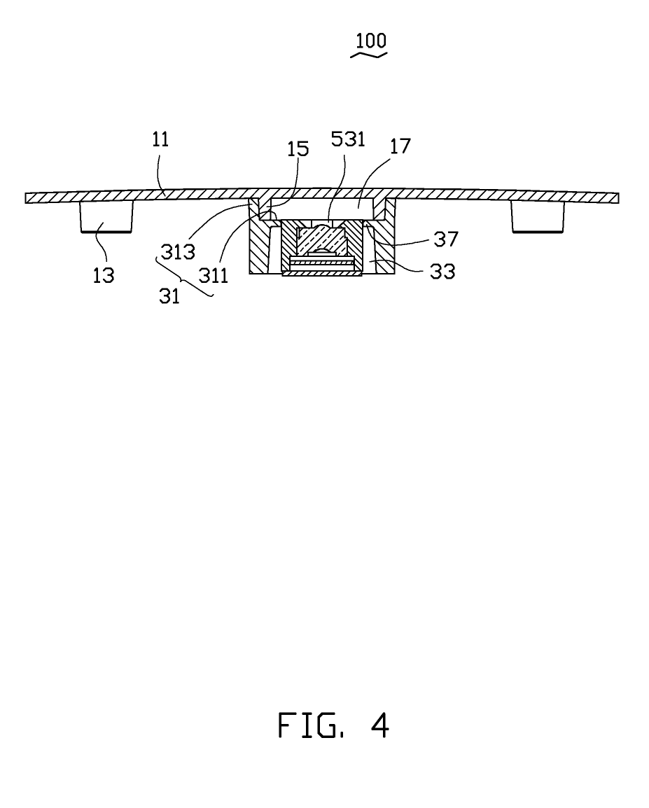

FIG. 3 is an isometric view of a gasket of the camera module of FIG. 1. FIG. 4 is an enlarged and cross-sectional view of the camera module shown in FIG. 1 taken along a line IV-IV of FIG. 1. The gasket 30 is cylinder-shaped, one end surface of the gasket 30 defines a mounting groove 31, another end surface of the gasket 30 defines a receiving cavity 33 (shown in FIG. 1). The mounting groove 31 includes a bottom wall 311 and a peripheral wall 313 surrounding the bottom wall 311. The connecting arm 15 is received in the mounting groove 31 (see FIG. 4). The bottom wall 311 contacts with and is fixed to a bottom surface of the connecting arm 15, and the peripheral wall 313 contacts with and is fixed to an outer surface of the connecting arm 15, such that the mounting groove 31 is fixed to the transparent window 10. Since the gasket 30 is fixed to the connecting arm 15 by double-colored injection molding technology, the coaxial arrangement of the transparent window 10 and the gasket 30 receiving the lens module 50 can be ensured.

The gasket 31 further includes a through hole 35 defined through the bottom wall 311 and communicating with the receiving cavity 33, thereby forming a flange 37 that protrudes substantially perpendicularly from the peripheral wall 313 correspondingly. In the exemplary embodiment, the through hole 35 is circular-shaped hole. The through hole 35 is defined in a central portion of the bottom wall 31, and is coaxial with the light penetration chamber 17, the mounting groove 31, and the receiving cavity 33. When the camera module 100 is mounted to the electronic device, a photo flash (not shown) is usually mounted adjacent to the camera module 100. The flange 37 and the peripheral wall 313 are configured to prevent image quality of the camera module 100 from being affected by refracting light of the photo flash. In addition, the flange 37 is further configured to facilitate the ejection of the molded transparent window 10 and the gasket 30. For example, an ejecting apparatus (not shown) can resist against the flange 37 to eject the molded transparent window 10 and the gasket 30 out of a mold (not shown).

The receiving cavity 33 is configured to receive the lens module 50. A plurality of guiding slots 331 are longitudinally defined in a peripheral wall (not labeled) of the receiving cavity 33. The guiding slots 331 are arranged corresponding to corners (not labeled) of the lens module 50, to guide the lens module 50 when assembling the lens module 50 to the gasket 30.

The lens module 50 includes a holder 51 (shown in FIG. 2) and a barrel 53 mounted on the holder 51. A lens exposing hole 531 (shown in FIG. 4) is defined through a distal end of the barrel 53. The holder 51 is received within the receiving cavity 33. The distal end of the barrel 53 is received within the through hole 35, and the remainder of the barrel 53 is received within the receiving cavity 33. The lens exposing hole 531 is aligned with the light penetration chamber 17, such that ambient light is allowed to be entered into the light sensor (not labeled) of the lens module 50 via the transparent window 10 and the lens exposing hole 531. A diameter of the through hole 35 is slightly larger than a diameter of the barrel 53, such that the coaxial arrangement of lens module 50 and the gasket 30 can be ensured.

The transparent window 10 and the gasket 30 are integrally formed together, such that the coaxial arrangement of the transparent window 10 and the gasket 30 can be ensured. Therefore, the disclosure provides a camera module 100 where all necessary components are coaxial. In addition, the transparent window 10 is able to connect to the gasket 30 hermetically, which can prevent the lens module 50 from being contaminated.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

1. A camera module, comprising:
a transparent window;
a gasket integrally formed with the transparent window by double-colored injection molding technology, the gasket defining a receiving cavity and a plurality of guiding slots longitudinally defined in an internal peripheral wall of the receiving cavity, each guiding slot extending from one end of the receiving cavity to the other end of the receiving cavity; and
a lens module received in the receiving cavity, the lens module comprising a lens exposing hole that aligns with the transparent window, and allows ambient light to be transmitted into the lens module;
wherein the guiding slots are configured to guide the lens module to be assembled into the gasket.

2. The camera module of claim 1, wherein the transparent window is made of plastic material, the gasket is made of matt elastic material.

3. The camera module of claim 1, wherein the transparent window comprises a board and a connecting arm protruding from the board, the connecting arm is a hollow cylinder that cooperates with the board to define a light penetration chamber therebetween, the light penetration chamber has a round bottom wall surrounded by the connecting arm; the gasket defines a mounting groove opposite to the receiving cavity, a peripheral wall of the mounting groove contacts with and is fixed to an outer surface of the connecting arm.

4. The camera module of claim 3, wherein a bottom wall of the mounting groove contacts with and is fixed to a bottom surface of the connecting arm.

5. (canceled)

6. The camera module of claim 3, wherein the gasket further comprises a through hole defined through the bottom wall of the mounting groove and communicating with the receiving cavity, such that forming a flange that protrudes substantially perpendicularly from the peripheral wall of the mounting groove correspondingly.

7. The camera module of claim 6, wherein the lens module comprises a holder and a barrel mounted on the holder, the lens exposing hole is defined through a distal end of the barrel; the holder is received within the receiving cavity, the distal end of the barrel is received within the through hole, and the remainder of the barrel is received within the receiving cavity.

8. (canceled)

9. The camera module of claim 3, wherein the transparent window further comprises a plurality of mounting posts protruding from the board, the mounting posts are configured to be fixed to a portable electronic device.

10. A camera module, comprising:
a light penetration chamber;
a transparent window covering the light penetration chamber;
a gasket integrally formed with the transparent window, the gasket comprising a receiving cavity coaxial with the light penetration chamber and defining a plurality of guiding slots longitudinally defined in an internal peripheral wall of the receiving cavity, each guiding slot extending from one end of the receiving cavity to the other end of the receiving cavity; and
a lens module received in the receiving cavity, the lens module comprising a lens exposing hole that aligns with and is coaxial with the light penetration chamber, the lens exposing hole allowing ambient light to be transmitted into the lens module;
wherein the guiding slots are configured to guide the lens module to be assembled into the gasket.

11. The camera module of claim 10, wherein the transparent window is made of plastic material, the gasket is made of matt elastic material.

12. The camera module of claim 10, wherein the transparent window comprises a board and a connecting arm protruding from the board, the connecting arm is a hollow cylinder that cooperates with the board to define the light penetration chamber therebetween, the light penetration chamber has a round bottom wall surrounded by the connecting arm; the gasket defines a mounting groove opposite to the receiving cavity, a peripheral wall of the mounting groove contacts with and is fixed to an outer surface of the connecting arm.

13. The camera module of claim 12, wherein a bottom wall of the mounting groove contacts with and is fixed to a bottom surface of the connecting arm.

14. The camera module of claim 12, wherein the gasket further comprises a through hole defined through the bottom wall of the mounting groove and communicating with the receiving cavity, such that forming a flange that protrudes substantially perpendicularly from the peripheral wall of the mounting groove correspondingly.

15. The camera module of claim 14, wherein the lens module comprises a holder and a barrel mounted on the holder, the lens exposing hole is defined through a distal end of the barrel; the holder is received within the receiving cavity, the distal end of the barrel is received within the through hole, and the remainder of the barrel is received within the receiving cavity.

16. (canceled)

17. The camera module of claim 12, wherein the transparent window further comprises a plurality of mounting posts protruding from the board, the mounting posts are configured to be fixed to a portable electronic device.

18. The camera module of claim 5, wherein a diameter of the mounting groove is greater than a diameter of the receiving cavity.

19. The camera module of claim 12, wherein a diameter of the mounting groove is greater than a diameter of the receiving cavity.
